(19) United States
(12) Patent Application Publication
(10) Pub. No.: US 2007/0079683 A1
(43) Pub. Date: Apr. 12, 2007

(54) Display device for circular saw

(75) Inventor: Jung-Huo Chen, Taichung Hsien (TW)

Correspondence Address: BACON & THOMAS, PLLC, 625 SLATERS LANE, FOURTH FLOOR, ALEXANDRIA, VA, 22314, US

(73) Assignee: REXON INDUSTRIAL CORP., LTD., Taichung Hsien (TW)

(21) Appl. No.: 11/545,449

(22) Filed: Oct. 11, 2006

(30) Foreign Application Priority Data
Oct. 12, 2005 (TW) 094217610

(51) Int. Cl. B26D 5/08

(52) U.S. Cl. 83/581

(57) ABSTRACT

The present invention is a circular saw including a base, a blade movably extending through the first slot, a blade unit mounted to the base and connected with the blade, an adjustment unit connected with the blade unit for moving the blade unit relative to the base, an display device, and a connection member. The display device has a groove member fixed on the base, a spring member disposed into the groove member and an indication member disposed into the groove member. The spring member has an end connected to the groove member and the other end connected to the indication member. The connection member has one end connected to the blade unit and the other end connected to the indication member. The blade unit synchronously moves the blade and pulls the connection member to draw the indication member when the blade unit is moved.

### FIELD OF THE INVENTION

The present invention relates to a circular saw, and more particularly the circular saw has a display device.

### BACKGROUND OF THE INVENTION

A conventional table saw 80 is shown in FIG. 9 and generally includes a base 81 with a table 84 supported on the base 81, a slot 82 is defined through the table 84 so that the blade 85 extends through the slot 82 so as to cut objects on the table 84. A handwheel 86 is located on an outside of the base 81 and connected with the mechanism of the blade 85 such that when rotating the handwheel 86, the blade 85 is moved through the slot 82 vertically. Indication marks 83 are marked on the table 84 so that the user can check the specific mark 83 that meets the teeth of the blade 85 to acknowledged the height of the blade 85 above the table 84. However, the marks 83 are easily covered by debris during cutting and the user has to frequently wipe out the debris to see the marks 83, and this action is dangerous.

Another conventional table saw 90 is shown in FIG. 10 and the blade 91 has its own height marks 92 on the surface thereof. When rotating the handwheel 93, the blade 91 is moved through the slot 94 and the user can check the mark 92 that is in flush with the top of the table 95 to obtain the height of the blade 91 above the top of the table 95. Nevertheless, the marks 92 would be worn out after a period of time of use and cannot be seen clearly. Other measuring tool has to be used to check the height and this measurement involves tolerance and takes time.

### SUMMARY OF THE INVENTION

The present invention intends to provide a circular saw with a display device which is easy to check and safer for the user.

The circular saw includes a base, a blade, a blade unit, an adjustment unit, a display device, and a connection member. The base has a table supported on the base. The blade movably extends through a slot defined through the table. The blade unit is located in the base and connected with the blade so as to control the blade. The adjustment unit is connected with the blade unit for moving the blade unit relative to the table. The display device has a guide member with a groove, and the guide member is fixed on the base. A spring member and an indication member of the display device are disposed into the groove. The spring member has a first end connected to the guide member and a second end connected to the indication member. The connection member has one end connected to the blade unit and the other end connected with the indication member. When the blade unit is moved, the blade unit synchronously moves the blade and pulls the connection member to draw the indication member.

By means of the foresaid structure, the display device of the circular saw disclosed in the present invention can display the movement of the blade relative to the table outside of the base, so that the user can easily check and know the movement of the blade, for example, a height. Moreover, the display device is located far away from the blade so that the user can check the movement of the blade more safely than the prior art does.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the circular saw in the present invention;

FIG. 2 is an exploded view to show the display device of the circular saw in the present invention;

FIG. 3 is a schematic view to show that the blade in the present invention is located at a low position;

FIG. 4 is a schematic view to show that the indication member is located at a top of the slot of the base in the present invention;

FIG. 5 is a schematic view to show that the blade in the present invention is located at a high position;

FIG. 6 is a schematic view to show that the indication member is located at a bottom of the slot of the base in the present invention;

FIG. 7 is a schematic view to show another embodiment of the blade unit cooperated with the display device of the circular saw in the present invention;

FIG. 8 is a schematic view to show that the blade of the blade unit in FIG. 7 is raised to a high position;

FIG. 9 is a perspective view to show a first conventional height display device of a table saw, and

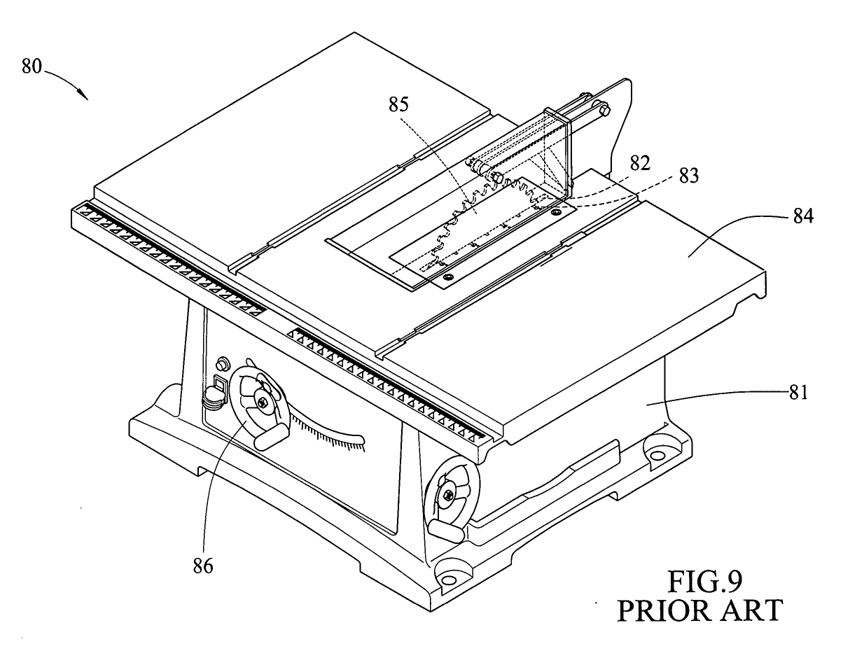

FIG. 10 is a perspective view to show a second conventional height display device of a table saw.

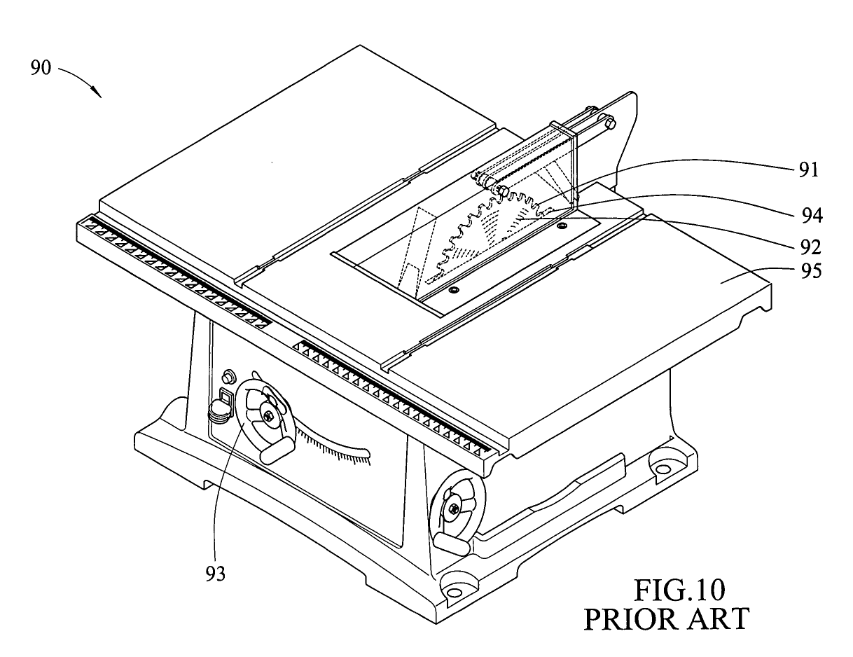

### DETAILED DESCRIPTION OF THE PREFERRED EMBODIMENT

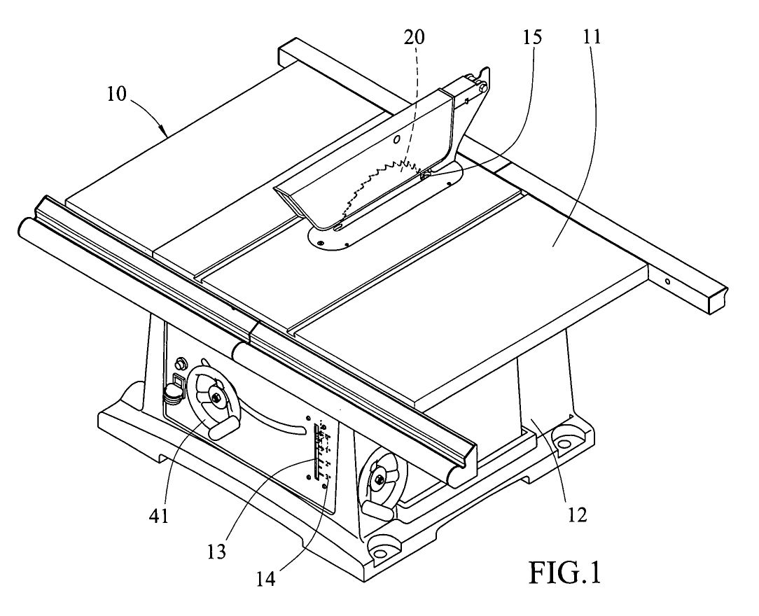

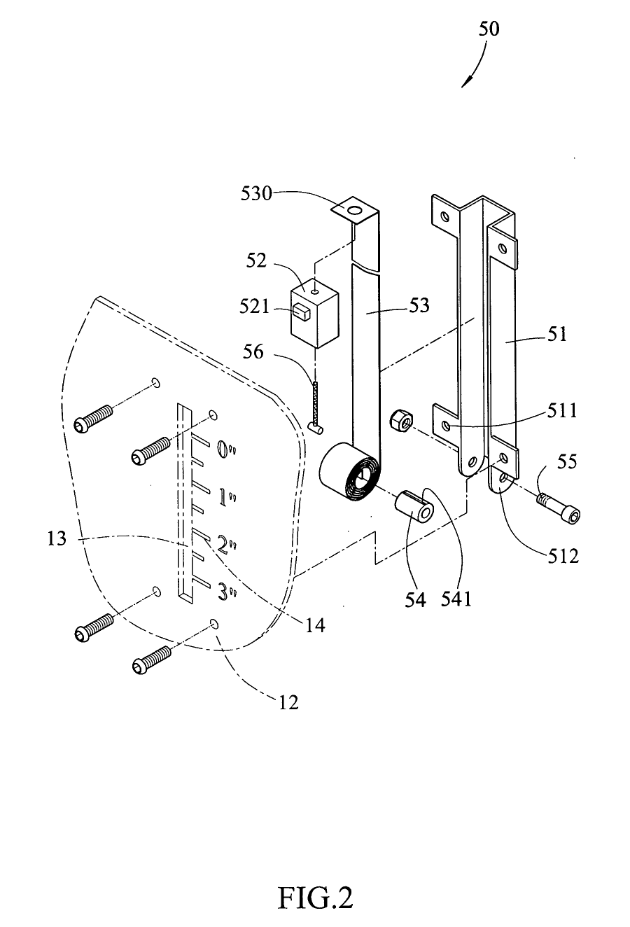

Referring to FIGS. 1 to 6, the circular saw 10 of the present invention, for example a table saw, comprises a base 12 with a table 11 supported on the base 12, a first slot 15 defined through the table 11 so that a blade 20 movably extends through the first slot 15. A blade unit 30 is pivotably located in the base 12 and connected with the blade 20 so as to control the blade 20. The blade unit 30 includes a threaded rod 32 and a bevel gear 31 is connected with the threaded rod 32. When the threaded rod 32 is rotated, the blade unit 30 is moved up and down. The blade unit 30 includes a motor 33 which is connected to and drives the blade 20.

An adjustment unit 40 is connected with the blade unit 30 for moving the blade unit 30 relative to the table 11 and includes a handwheel 41 which is located on outside of the base 12, and a rod 42. The rod 42 has one end connected to the handwheel 41 and the other end of the rod 42 is connected with the blade unit 30. Another bevel gear 43 is connected to the rod 42 and engaged with the bevel gear 31 of the blade unit 30. Therefore, when rotating the handwheel 41, the threaded rods 32, and the rod 42 are rotated so that the blade unit 30 is moved and the blade 20 is moved through the first slot 15.

An display device 50 has a guide member 51 which is an U-shaped member with four side lugs and each side lug has a hole 511 so as to be fixed to an inside of the base 12. A groove is defined in the guide member 51, a spring member 53 and an indication member 52 are received in the groove. The spring member 53 is a spring band shaped like a roll, whose first end is secured in a slot 541 of a mandrel 54 and the spring member 53 is wrapped around the mandrel 54. The guide member 51 has two end lugs 512 on an end thereof, and the display device 50 has a bolt 55 extending through the two end lugs 512 and the mandrel 54. A transverse portion 530 is bent from a second end of the spring member 53, and a connection member 56 has one end extending through the indication member 52 and a hole in the transverse portion 530 and the other end is fixed to the blade unit 30. The connection member 56 according to this embodiment is a line, prepferably a metal line. The base 12 includes a second slot 13 disposed on a side of the base 12 facing the user, and height marks 14 are located along the second slot 13. The indication member 52 includes a protrusion 521 which is inserted through the second slot 13 and thereby displayed to the outside of the base 12. Therefore, when the blade unit 30 is moved, the blade unit 30 synchronously moves the blade 20 and pulls the connection member 56 to draw the indication member 52.

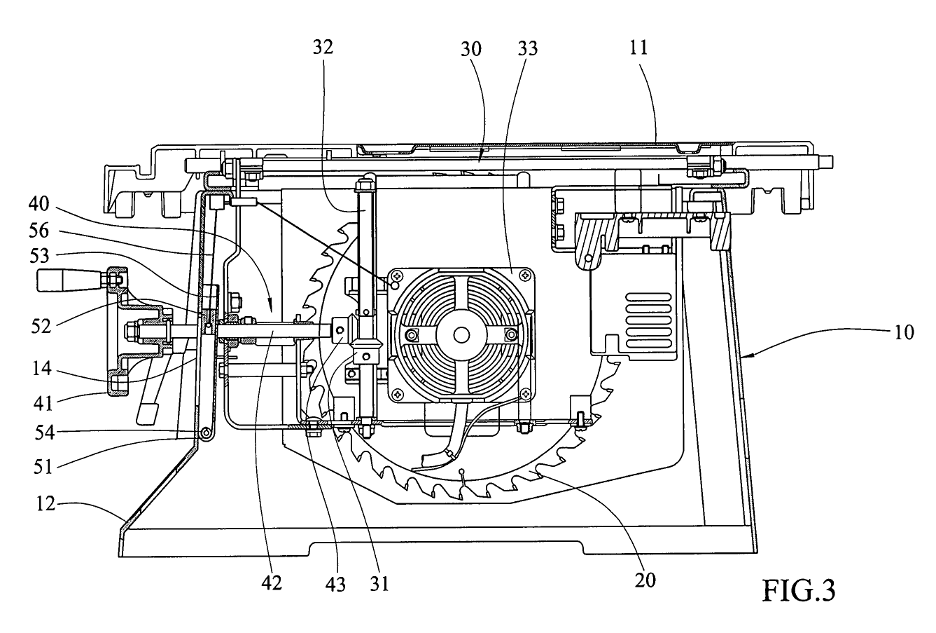

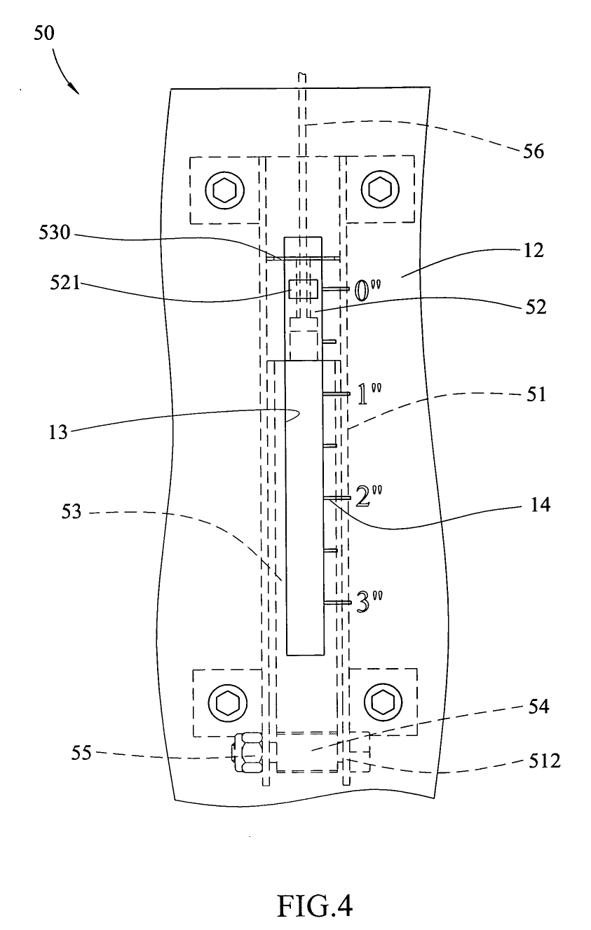

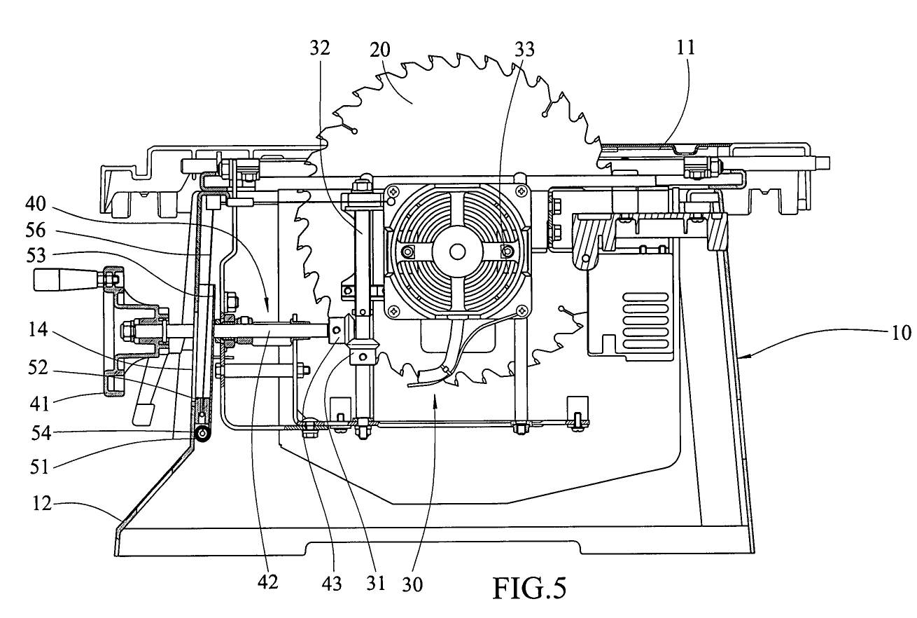

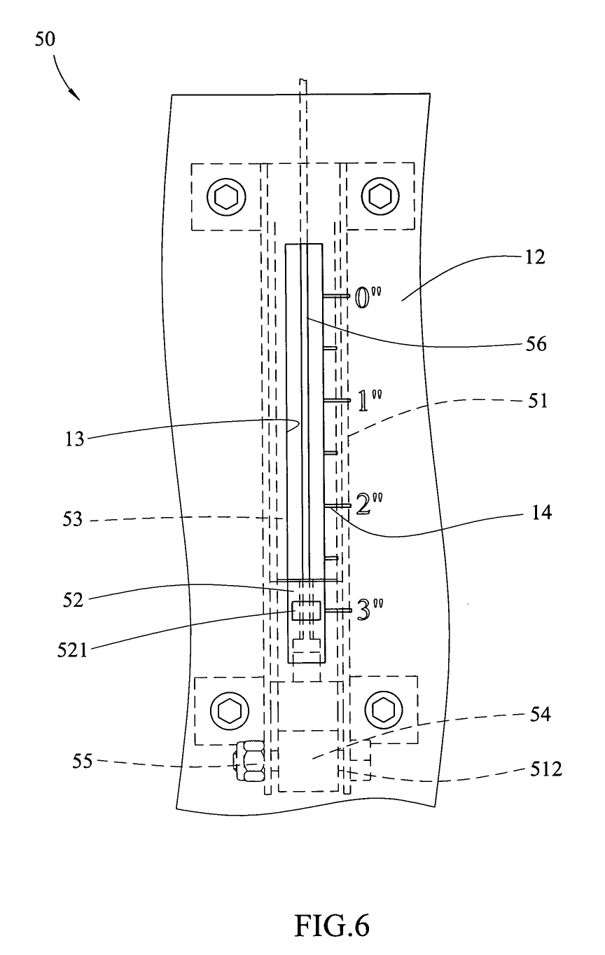

As shown in FIGS. 3 and 4, when the blade 20 is located at a lowest position, the connection member 56 is pulled so that the indication member 52 is located at a top of the second slot 13 in the base 12. On the contrary, as shown in FIGS. 5 and 6, when the blade 20 is located at a highest position, the connection member 56 is not stretched and the indication member 52 is located at a bottom of the second slot 13 in the base 12. By checking the alignment of the protrusion 521 on the indication member 52 and one of the marks 14, the user can easily obtain the information of the height of the blade 20 above the top of table 11.

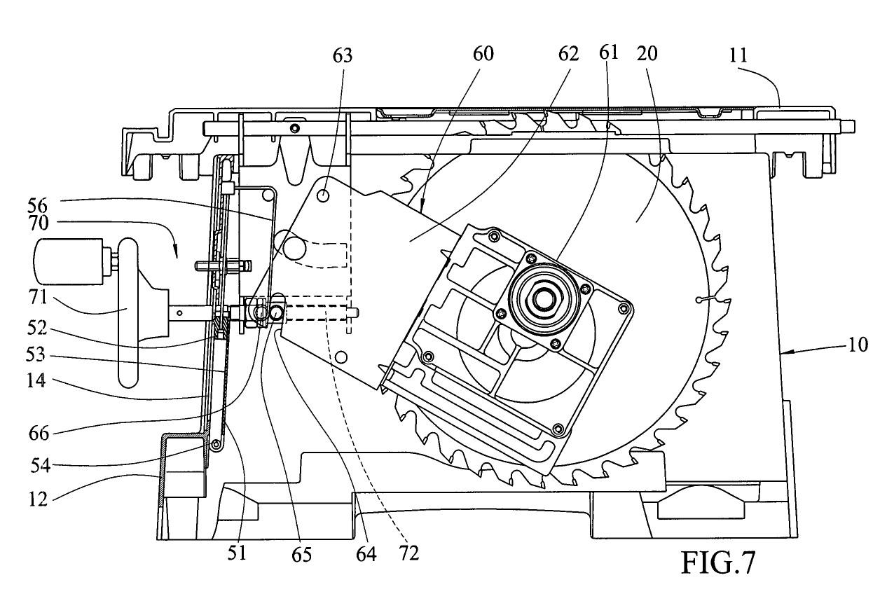

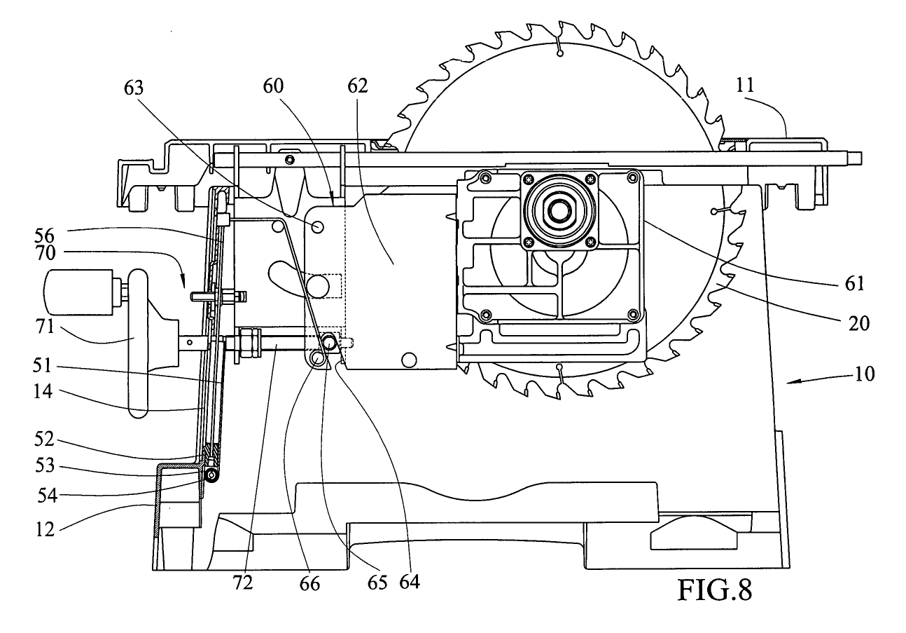

As shown in FIGS. 7 and 8, the display device 50 can also be cooperated with another type of blade unit 60 which includes a motor 61 to drive the blade 20 and a connection mechanism 62 is connected to the blade unit 60. The connection mechanism has a mounting member 63 as a pivotal point of the blade unit 60 and a guide recess 64. The other end of the connection member 56 is connected to a point 66 of the blade unit 60 at a distance from the mounting member 63.

The adjustment unit 70 includes a handwheel 71 and a threaded rod 72 which has one end connected to the handwheel 71 located outside of the base 12. The other end of the threaded rod 72 is connected with the blade unit 30. When rotating the handwheel 71, the blade unit 60 is pivoted about the mounting member 63. A movable member 65 is received in the guide recess 64 and threadedly mounted on the threaded rod 72. When rotating the handwheel 71, the movable member 65 moves in the guide recess 64 so as to pivot the connection mechanism 62 about the mounting member 63. By rotating the handwheel 71, the blade unit 60 is pivoted about the mounting member 63 and pulls the connection member 56 such that the indication member 52 is moved in the second slot 13 as previously described.

While we have shown and described the embodiment in accordance with the present invention, it should be clear to those skilled in the art that further embodiments may be made without departing from the scope of the present invention.

What is claimed is:

1. A circular saw comprising:
a base with a table supported thereon and a first slot defined through the table;
a blade movably extending through the first slot;
a blade unit mounted to the base and connected with the blade so as to control the blade;
an adjustment unit connected with the blade unit for moving the blade unit relative to the table;
an display device having a groove member fixed on the base, a spring member disposed into the groove member and an indication member disposed into the groove member, the spring member having a first end connected to the groove member and a second end connected to the indication member, and
a connection member having one end connected to the blade unit and the other end connected to the indication member, wherein the blade unit synchronously moves the blade and pulls the connection member to draw the indication member when the blade unit is moved.

2. The circular saw as claimed in claim 1, wherein the spring member is a spring band shaped like a roll.

3. The circular saw as claimed in claim 2, wherein the display device has a bolt extending through groove member and wrapped around by the spring member.

4. The circular saw as claimed in claim 3, wherein the connection member extends through the indication member and the second end of the spring member.

5. The circular saw as claimed in claim 1, wherein the base includes a second slot and marks arranged along the second slot, and the indication member is displayed through the second slot.

6. The circular saw as claimed in claim 5, wherein the second slot is provided on a side of the base facing a user.

7. The circular saw as claimed in claim 1, wherein the blade unit pivotably disposed in the base, and the end of the connection member is connected to the blade unit not at a pivoting point.

8. The circular saw as claimed in claim 7, wherein the adjustment unit includes a handwheel and a threaded rod which has one end connected to the handwheel located outside of the base and the other end is screwed into the blade unit.

9. The circular saw as claimed in claim 7, wherein the connection member is a line.

10. The circular saw as claimed in claim 1, wherein the display device is adapted to indicate a height of the blade above the table.

11. The circular saw as claimed in claim 1, is a table saw.
